(19) United States
(12) Patent Application Publication
(10) Pub. No.: US 2004/0041550 A1
(43) Pub. Date: Mar. 4, 2004

(54) Curvature-corrected band-gap reference with reduced processing sensitivity

(76) Inventor: Edmond Patrick Coady, Colorado Springs, CO (US)

Correspondence Address: OPPENHEIMER WOLFF & DONNELLY, P. O. BOX 10356, PALO ALTO, CA, 94303, US

(21) Appl. No.: 09/894,957

(22) Filed: Jun. 27, 2001

(51) Int. Cl. G05F 3/16

(52) U.S. Cl. 323/314

(57) ABSTRACT

Disclosed is band-gap circuit that overcomes the deficiencies of conventional band-gap circuits by compensating for high order temperature effects. The invention employs a resistor of high temperature sensitivity in parallel with a resistor having a low temperature sensitivity in the collector circuit of the transistors to counter inherent higher order temperature effects found in prior art circuits. Furthermore, the invention has a reduced sensitivity to the variables within manufacturing of integrated semiconductor devices.

### CROSS REFERENCE TO RELATED APPLICATIONS

Not Applicable.

### STATEMENT REGARDING FEDERALLY SPONSORED RESEARCH

Not Applicable.

### FIELD OF THE INVENTION

The instant invention relates to band-gap voltage reference circuits, and specifically to the class of band-gap circuits which provide a higher degree of temperature stability by correcting for higher order linearity terms.

### BACKGROUND OF INVENTION

Band-gap voltage reference circuits provide an output voltage that remains substantially constant over a wide temperature range. These reference circuits operate under the principle of adding a first voltage with a positive temperature coefficient to a second voltage with an equal but opposite negative temperature coefficient. The positive temperature coefficient voltage is extracted from a bipolar transistor in the form of the thermal voltage, kT/q (V.sub.T), where k is Boltzman's constant, T is absolute temperature in degrees Kelvin, and q is the charge of an electron. The negative temperature coefficient voltage is extracted from the base-emitter voltage (V.sub.BE) of a forward-biased bipolar transistor. The band-gap voltage, which is insensitive to changes in temperature, is realized by adding the positive and negative temperature coefficient voltages in proper proportions.

A conventional band-gap circuit is shown in FIG. 1. In such prior art circuits, all resistors are manufactured similarly, so the ratio of R3 20 to R4 30 would remain constant over temperature. An operational amplifier maintains an equal voltage across R3 20 and R4 30, thereby keeping the ratios of currents (IC1 to IC2) into the collectors of Q1 40 and Q2 50 equal over temperature also. The emitter areas of transistors Q1 40 and Q2 50 are in a ratio of A to nA with the emitter area of Q2 50 scaled larger than that of Q1 40 by a factor of n. The resulting collector currents and base to emitter voltages of the two transistors result in a voltage across R1 equal to kT/q ln(n×IC1/IC2). The expression for the voltage across R1 is directly proportional to absolute temperature. The voltage across R1 is amplified across R2 by the factor 2×R2/R1, when R3 equals R4.

The band-gap circuit functions by taking voltages that are positively and negatively changing with respect to temperature, and adding them to obtain a substantially constant output voltage with respect to temperature. Specifically, the base to emitter voltage of Q1 has a negative temperature coefficient, while the voltage across R2 has a positive temperature coefficient. By taking the output of the circuit at the base of Q1, the positive and negative temperature coefficients essentially cancel, so the output voltage remains constant with respect to temperature.

A first-order analysis of a band-gap reference circuit approximates the positive and negative temperature coefficient voltages to be exact linear functions of temperature. The positive temperature coefficient voltage generated from V_{T} is in fact extremely linear with respect to temperature. The generated negative temperature coefficient voltage from the V_{BE} of a bipolar transistor contains higher order non-linear terms that have been found to be approximated by the function Tln(T), where ln(T) is the natural logarithm function of absolute temperature. When the band-gap voltage is generated using conventional circuit techniques, the Tln(T) term and other higher order terms remain and are considered as error terms which compromise the accuracy of the reference output voltage.

The present invention aims to create terms equal and opposite to the Tln(T) higher order terms to improve the temperature characteristics of the band-gap reference. The invention aims to introduce these correction terms in a manner which is not sensitive to poorly controlled parameters within the semiconductor manufacturing process.

### SUMMARY OF INVENTION

The invention is to improve the accuracy of band-gap voltage reference circuits with respect to temperature variations. Conventional band-gap circuits exhibit a variation in output voltage when ambient temperature changes. Conventional band-gap output voltages will exhibit a parabolic characteristic when plotted versus temperature. The present invention reduces the magnitude of this voltage error by adding resistors with both high and low temperature sensitivity to the collector circuit of a transistor in a band-gap circuit. The high and low temperature coefficient resistors are arranged in parallel to reduce circuit dependence on poorly controlled process parameters inherent in the semiconductor manufacturing process.

### BRIEF DESCRIPTION OF DRAWINGS

FIG. 1 shows a conventional PRIOR ART band-gap circuit.

FIG. 2 shows the band-gap circuit of the instant invention.

### DETAILED DESCRIPTION OF INVENTION

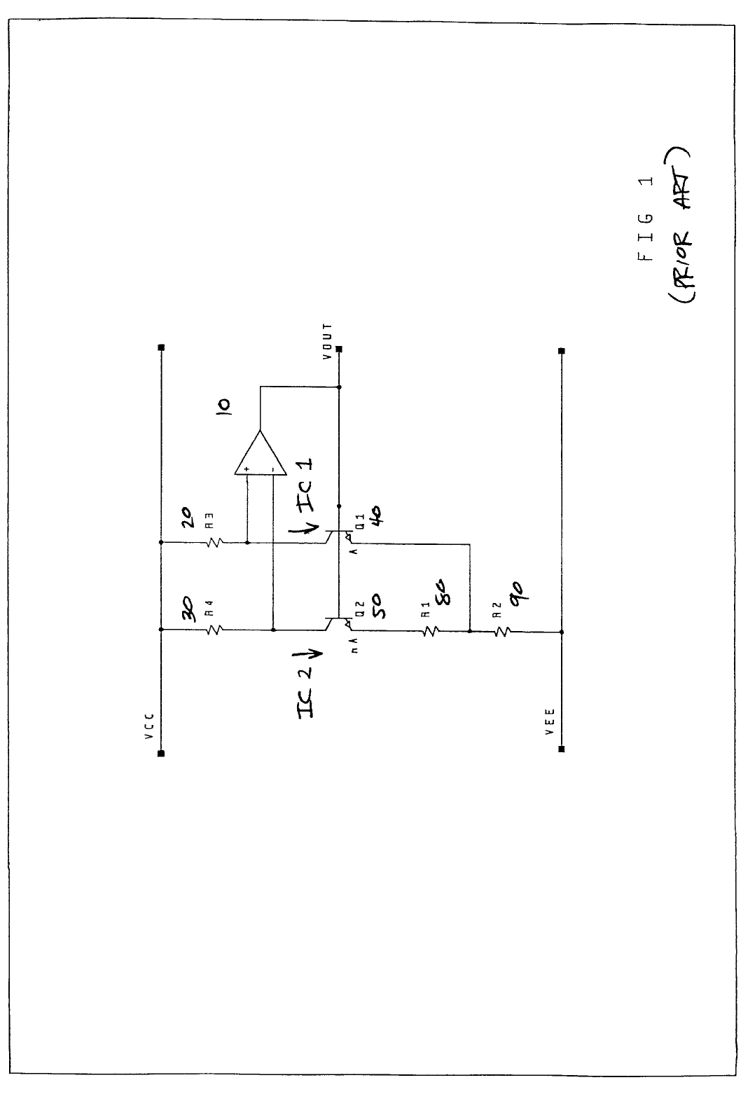

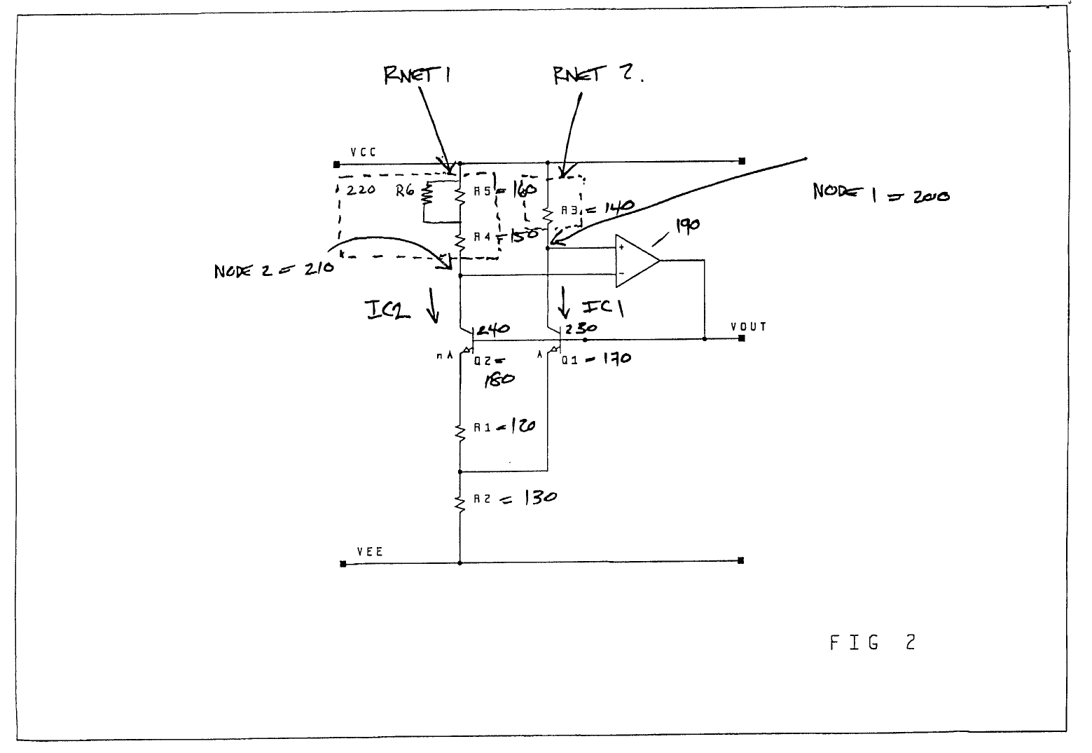

The instant invention band-gap reference circuit with reduced processing sensitivity described with reference to FIG. 2 compensates for the Tln(T) variation found in conventional implementations of band-gap circuits. This invention comprises a source voltage VCC, resistors R1, R2, R3, R4, R5, and R6 transistors Q1 and Q2 and one operational amplifier A1. A prior band-gap reference circuit with no compensation for Tln(T) will be referred to with reference to FIG. 1.

FIG. 1 shows a resistor R4 30, that forms a first resistor network that provides a current IC2 into the collector of Q2. Similarly, resistor R3, 20 may be considered as a second resistor network that is connected in series with the collector of Q1 40 and will draw a current IC1 from VCC into the collector of Q1 40. There are various circuit techniques available to equalize the voltage across the first and second resistor networks. One such technique is to connect the non-inverting and inverting inputs of operational amplifier A1 10 to the collector nodes of transistors Q1 and Q2, respectively and to connect the output of the operational amplifier to the base circuits of Q1 40 and Q2 50. The ratio of the collector current of Q1 40 to the collector current of Q2 50 is determined solely by the ratio of the resistance value of first resistor network to the second resistor network.

Prior band-gap circuits have maintained a specifically constant ratio between the collector currents of Q1 40 and Q2 50. The prior art circuit in FIG. 1 uses identical geometry resistors manufactured using the same process step to maintain a constant ratio of R3 20 to R4 30 with variations in temperature. It is known when a constant current-density ratio greater than unity is maintained between Q1 40 and Q2 50 that a proportional to absolute temperature voltage is developed between the emitters of Q1 40 and Q2 50. The current density ratio of Q1 40 to Q2 50 is determined by resistor values R3 20 and R4 30 and emitter area ratio of Q1 40 to Q2 50, denoted as n in FIG. 1.

$$Δ {V}_{R1} = \frac{kT}{q} ln ( n \cdot \frac{R4}{R3} ) \qquad ( 1 )$$

Equation (1), where k is Boltzman's constant, q is the charge of an electron, T is absolute temperature in Kelvin, and R3 20, R4 30 and n are as denoted in FIG. 1, shows that a proportional to temperature voltage is developed across R1 80. The voltage across R1 80 is amplified by (1+R4/R3)×(R2/R1) and added to the base-emitter voltage of Q1 40 to create the band-gap voltage.

Referring back to FIG. 2, the present invention purposely introduces a temperature dependence to the ratio of resistor networks RNET1 and RNET2, this is a substantial departure from the architecture of prior band-gap circuits. R3 140, R4 150 and R6 220, are preferably thin film resistors with a low TCR. R5 160 is built in such a way as to have a high TCR comparatively to R3 140, R4 150 and R6 220. In practice, various materials, such as a diffused resistor, can be used to build R5 160 to realize a high value of TCR.

$$Δ {V}_{R1} ≅ \frac{kT}{q} \cdot ln [ n \cdot ( 1 + \frac{{R}_{0}}{{R}_{4} + {R}_{0}} ( \frac{1}{2} ( T - {T}_{0} ) \cdot {TC}_{R5} - \frac{1}{4} {( T - {T}_{0} )}^{2} {TC}_{R5}^{2} ) ) ] \qquad ( 2 )$$

From equation (2), where R₀ is equal to the parallel combination of R5 and R6 with the temperature equal to T₀ (preferably room temperature) and TC_{R5} is the temperature coefficient of R5, it is apparent that the circuit arrangement in the present invention introduces additional higher order temperature terms. Equation (2) approximates the temperature dependence of the parallel combination of R5 and R6 using a three-term Taylor series expansion of the exact expression.

ΔVR1 is then amplified by (1+RNET1/RNET2)×(R2/R1) and added to the base emitter voltage of Q1 170. By proper selection of these of circuit component values, the higher order temperature terms introduced by the addition of R5 160 and R6 220, can be set to approximately cancel the T ln(T) terms and the higher order terms that is arise in the base-emitter voltage expressions of Q1 170 and Q2 180. This is a substantial departure from the prior art band-gap circuits that avoid temperature dependent collector current ratios. The present invention therefore maintains an output voltage at the operational amplifier that remains substantially constant with respect to temperature.

This instant invention does not have a large sensitivity to variations in the value of R5 and R6. Typical semiconductor manufacturing processes have variations as large as ±20% in the absolute value of manufactured resistors. Because R3, R4, and R6 are manufactured using a step of the semiconductor process to produce a relatively low TCR and R5 is manufactured to produce a relatively high TCR, their values will vary independently of each other with variations in the manufacturing process. The present invention adds a temperature coefficient term to the current ratio of IC1 to IC2. The TC of this IC1 to IC2 ratio is repeatable in the presence of large process variations within the manufacturing process.

Equation (3) shows the TC variation of the parallel combination of R5 and R6 with respect to variations in R5 (the partial derivative of TC_{R5∥R6} with respect to R5). For the specific case shown in Equation (4), where R5 equals R6, an incremental increase in resistance R5 will lower the TC of the network by ¼ of this percentage increase.

$$\frac{\partial }{\partial {R}_{5}} ( \frac{\frac{\partial }{\partial T} ( {R}_{5} ‖ {R}_{6} )}{{R}_{5} ‖ {R}_{6}} ) {\vert}_{T = {T}_{0}} = - \frac{{R}_{6}}{{( {R}_{5} + {R}_{6} )}^{2}} \cdot {TC}_{R5} \qquad ( 3 )$$

for the special case of R₅=R₆:

$$\frac{\partial }{\partial {R}_{5}} ( \frac{\frac{\partial }{\partial T} ( {R}_{5} ‖ {R}_{6} )}{{R}_{5} ‖ {R}_{6}} ) {\vert}_{T = {T}_{0}} = - \frac{{TC}_{R5}}{4} \cdot \frac{1}{{R}_{5}} \qquad ( 4 )$$

Equation (5) shows the sensitivity of resistance R5∥R6 to variations in R5. For the special case where R5 equals R6, shown in equation (6), the sensitivity of the resistance R5∥R6 to changes in R5 is ¼.

$$\frac{\partial }{\partial {R}_{5}} ( {R}_{5} ‖ {R}_{6} ) = \frac{\partial }{\partial {R}_{5}} ( \frac{{R}_{5} {R}_{6}}{{R}_{5} + {R}_{6}} ) = {( \frac{{R}_{6}}{{R}_{5} + {R}_{6}} )}^{2} \qquad ( 5 )$$

for the special case of R₅=R₆:

$$\frac{\partial }{\partial {R}_{5}} ( {R}_{5} ‖ {R}_{6} ) = \frac{1}{4} \qquad ( 6 )$$

Equation (4) and (6) together show that the net effect of a change in the high TCR resistor R5 is zero for this first order analysis. As R5 increases by given percentage the resistance R5∥R6 will increase by ¼ of this percentage. Also, as R5 is increased by a given percentage, the linear term of TC of R4∥R5 will decrease by ¼ of this percentage. The increase in resistance value of R5∥R6 is offset by an equal and opposite decrease in the linear TC component of this network.

Bandgap reference circuits with additional uncertain linear TC term are inherently more difficult to manufacture. These circuits require additional circuitry in order to compensate for variations in linear TC term added by the curvature compensation. In some cases this variability would necessitate costly and complicated temperature testing to measure this additional error term and complicated trimming techniques are required to remove the error. The instant invention reduces both the absolute resistance variation and the TC variation of the network formed by R5 and R6. As a result, the temperature dependent network introduces a first order temperature coefficient which is stable with respect to process variations. The stability of the first order component TC term added by the curvature compensation circuit simplifies the manufacturing of the bandgap circuit and increases the accuracy of the circuit. Essentially, adding a temperature sensitive resistor (R5) to the collector circuit of Q2 introduces a temperature dependent current ratio. The addition of R6 in parallel with R5 reduces the temperature sensitivity of this current ratio.

Therefore, although circuit analysis is much more difficult with the introduction of a temperature dependent current ratio into the pair of transistors, this allows for correction of higher order terms previously ignored in prior art band-gap circuits. It is noted that disclosed is merely one method of creating a temperature dependent current ratio, those skilled in the art may be able to produce other such means to accomplish this. For example only one particular method is disclosed for producing a temperature dependent current ratio through the transistors. This temperature dependent ratio may also be produced by introducing any type of temperature variations between the first and second resistor networks. If the first resistor network has a high temperature dependence the second resistor network may have a substantial temperature dependence also but different in magnitude from the first resistor networks.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds, are therefore intended to be embraced by the appended claims

We claim:

1. A band-gap voltage reference circuit comprising:
a first and second transistor, each having base, collector and emitter electrodes;
a first resistor network connected to a collector electrode of a first transistor that contains a first resistor that has a high temperature coefficient and a second resistor that has a low temperature coefficient;
a second resistor network connected to a collector electrode of a second transistor;
amplifier means coupled to said pair of transistors to produce an output signal responsive to the difference between the voltages across said pair of resistor networks;
a feedback circuit coupled to said amplifier means and developing a feedback signal corresponding to said output signal;
means to establish different current densities in the separate transistors of said pair of transistors, wherein said current densities vary in response to the ratio of the first and second resistor networks; and wherein said means provides an output voltage that is temperature compensated to a third order.

2. An apparatus as in claim 1, wherein said first resistor network comprises a third resistor connected in parallel to the first resistor

3. An apparatus as in claim 2, wherein a ratio of current densities changes as a function of temperature.

4. An apparatus as in claim 3, wherein the ratio of current densities is greater than unity.

5. An apparatus as in claim 4, wherein said band-gap circuit comprises a third resistor network connected to the emitter electrodes of said transistors.

6. An apparatus as in claim 5, wherein said third resistor network comprises a fifth resistor connected in series with the emitter electrode of said first transistor.

7. An apparatus as in claim 6, wherein said third resistor network comprises a sixth resistor connected in series with the emitter electrode of said second transistor.

8. An apparatus as in claim 7, wherein said second, third, fourth, fifth and sixth resistors have low temperature coefficients.

9. An apparatus as in claim 8, wherein said band-gap circuit output voltage has a temperature coefficient of less than 0.17 parts per million/degree Celsius.

10. A band-gap voltage reference circuit comprising:
a pair of transistors each having base, collector and emitter electrodes;
amplifier means having its input coupled to said pair of transistors to produce an output responsive to the difference between the currents through said pair of transistors;
means to produce different current densities in said pair of transistors, wherein a ratio of the current densities is temperature dependent;
an output circuit for said amplifier means and including an output terminal to develop an output voltage;
a first resistor network connected to a collector of a first transistor wherein a first resistor has a high temperature coefficient; wherein the high temperature coefficient of the first resistor compensates for higher order temperature variations of the output voltage.

11. An apparatus as in claim 10, wherein said first resistor network comprises at least two resistors in series with said collector.

12. An apparatus as in claim 11, wherein said first resistor network comprises a resistor with a high temperature coefficient and a resistor with a low temperature coefficient.

13. An apparatus as in claim 12, wherein a second resistor network is connected to the emitters of the transistors.

14. An apparatus as in claim 13, wherein said second resistor network comprises two resistors that have a low temperature coefficient.

15. An apparatus as in claim 14, wherein the first resistor network comprises a resistor with a low temperature coefficient in parallel with a resistor having a high temperature coefficient.

16. A band-gap output voltage reference circuit comprising:
an output circuit for developing an output voltage from a temperature dependent current ratio; and
a means for limiting the sensitivity of said temperature dependent current ratio.

17. The apparatus as in claim 16, wherein the output circuit includes an operational amplifier.

18. The apparatus as in claim 16, further comprising a means to produce a temperature dependent current ratio which includes a pair of transistors and a first resistor network and a second resistor network.

19. The apparatus as in claim 18, wherein the first resistor network contains a first resistor with a high temperature coefficient and a second resistor with a low temperature coefficient.

20. The apparatus as in claim 19, wherein the first resistor is connected in parallel to the second resistor.
